(19) United States
(12) Patent Application Publication
(10) Pub. No.: US 2019/0001469 A1
(43) Pub. Date: Jan. 3, 2019

(54) SOCKET WITH DRIVING PROTRUSIONS

(71) Applicants: Yao-Lin Cho, Taichung City (TW); Zi-Yan Huang, Taichung City (TW); Chih-Chao Chang, Taichung City (TW)

(72) Inventors: Yao-Lin Cho, Taichung City (TW); Zi-Yan Huang, Taichung City (TW); Chih-Chao Chang, Taichung City (TW)

(21) Appl. No.: 15/638,369

(22) Filed: Jun. 30, 2017

(51) Int. Cl. B25B 13/06; B25B 23/00

(52) U.S. Cl. CPC B25B 13/065; B25B 23/0035

(57) ABSTRACT

A socket includes a body with a mounting hole which includes multiple faces. Each face includes a first protrusion and two groups of second protrusions which are located on two sides of the first protrusion. A first imaginary plane extends in parallel from the distal surface of each first protrusion. Two second imaginary planes respectively extend laterally from the center of the distal surface of each first protrusion. An angle is defined between the first imaginary plane and each of the second imaginary planes. Each of the second imaginary planes pass respective distal surfaces of the second protrusions of each group in parallel. A notch is defined between adjacent second protrusions. A groove is defined between adjacent faces of the mounting hole.

### BACKGROUND OF THE INVENTION

### 1. Fields of the Invention

The present invention relates to a socket, and more particularly, to a socket with a mounting hole, and each face of the mounting hole includes a first protrusion and multiple second protrusions for loosening a rounded or damaged object.

### 2. Descriptions of Related Art

Sockets are provided with a mounting hole which generally is a polygonal hole, the polygonal hole includes multiple faces which are designed to be in contact with sides of a nut or a bolt head. The sockets can be connected with a tool such as a wrench, and when the wrench is rotated, the socket is rotated to loosen the nut or bolt head. However, if the nut or bolt head is rounded or damaged, the faces of the polygonal hole are not in contact with the sides of the nut or bolt head, then the rotation of the socket cannot drive the nut or bolt head.

The present invention intends to provide a socket that includes protrusions on each face of the mounting hole of the socket so as to be securely engaged with the object to eliminate the shortcomings mentioned above.

### SUMMARY OF THE INVENTION

The present invention relates to a socket and comprises a body with a mounting hole which includes multiple faces. Each face includes a first protrusion protruding from the central portion thereof. A first imaginary plane extends in parallel from the distal surface of each first protrusion. Two second imaginary planes respectively extend laterally from the center of the distal surface of each first protrusion. An angle is defined between the first imaginary plane and each of the second imaginary planes. Multiple second protrusions protrude from each face of the mounting hole and are arranged into two groups respectively locate don two sides of the first protrusion. Each of the second imaginary planes pass respective distal surfaces of the second protrusions of each group in parallel.

Preferably, the angle is larger than 0 degree, and the maximum value of the angle is 5 degrees.

Preferably, the angle is 2 degrees

Preferably, a groove is defined axially between adjacent faces of the mounting hole.

Preferably, a notch is defined axially between adjacent second protrusions.

Preferably, the body includes a connection section and a driving section. The mounting hole in the connection section is a first hole which is a rectangular hole, and the mounting hole in the driving section is a second hole which is a polygonal hole.

The primary object of the present invention is to provide a socket which is able to be securely mounted to a rounded or damaged nut or bolt head, and is able to loosen the rounded or damaged nut or bolt head.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the socket of the present invention;

FIG. 2 is a top view to show the socket of the present invention;

FIG. 3 is an enlarged view to show each face of the mounting hole of the socket of the present invention;

FIG. 4 shows the socket of the present invention, a wrench and a normal bolt;

FIG. 5 shows that the bolt is accommodated in the mounting hole of the socket of the present invention;

FIG. 6 shows the socket of the present invention, a wrench and a rounded bolt;

FIG. 7 shows that the rounded bolt is accommodated in the mounting hole of the socket of the present invention;

FIG. 8 shows that the socket is rotated, and the second protrusions of the socket of the present invention are engaged with the rounded bolt, and

FIG. 9 is an enlarged view to show each face of the mounting hole of the socket of the present invention and the rounded bolt.

### DETAILED DESCRIPTION OF THE PREFERRED EMBODIMENT

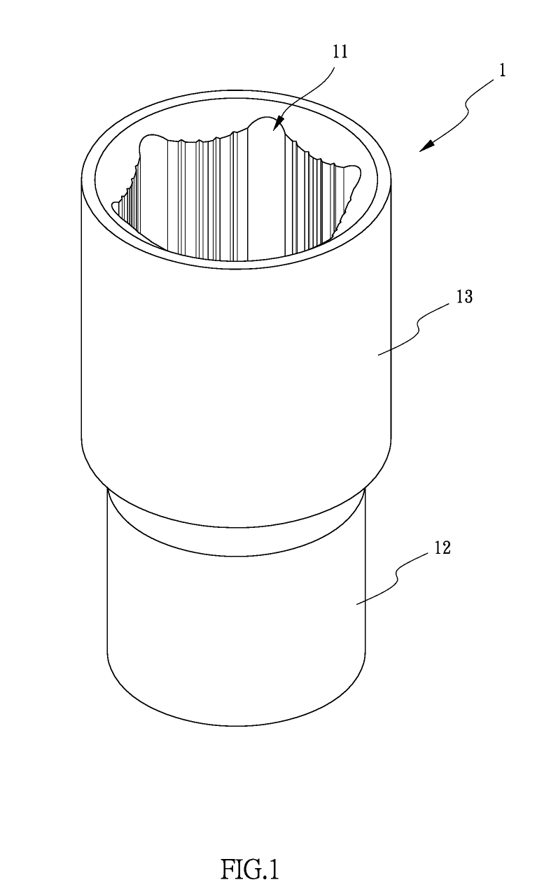

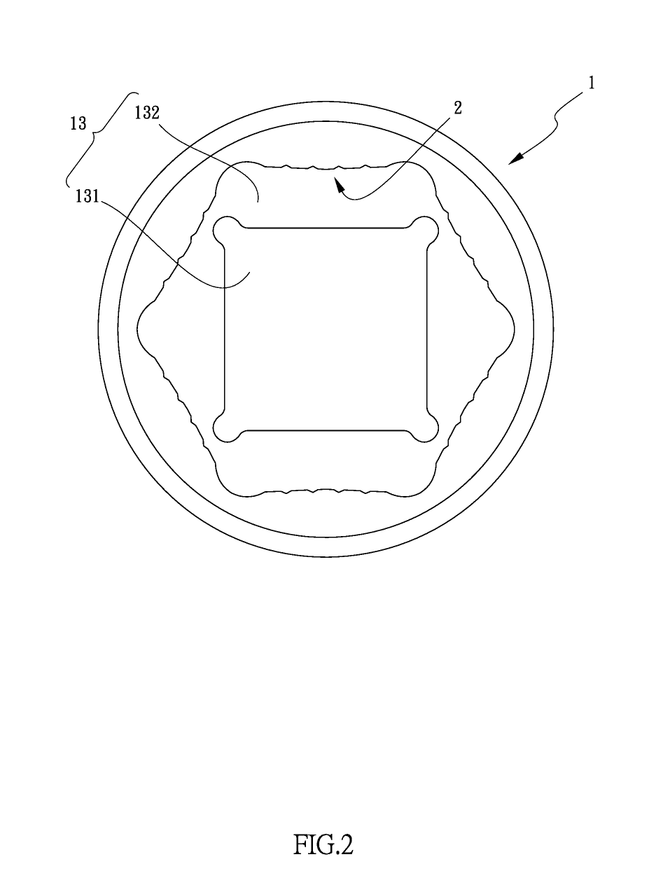

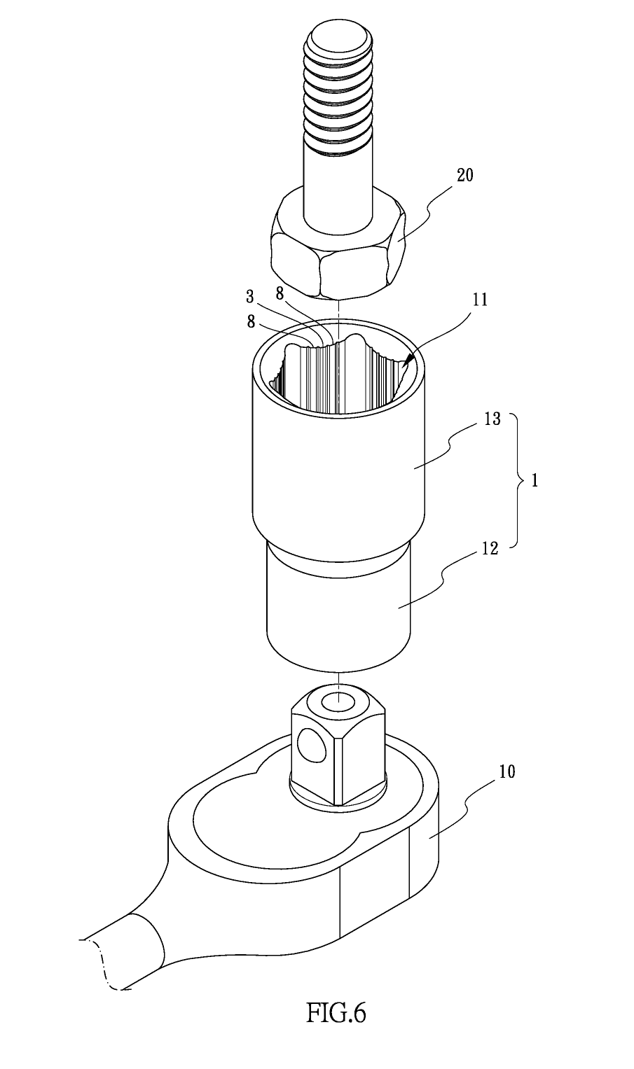

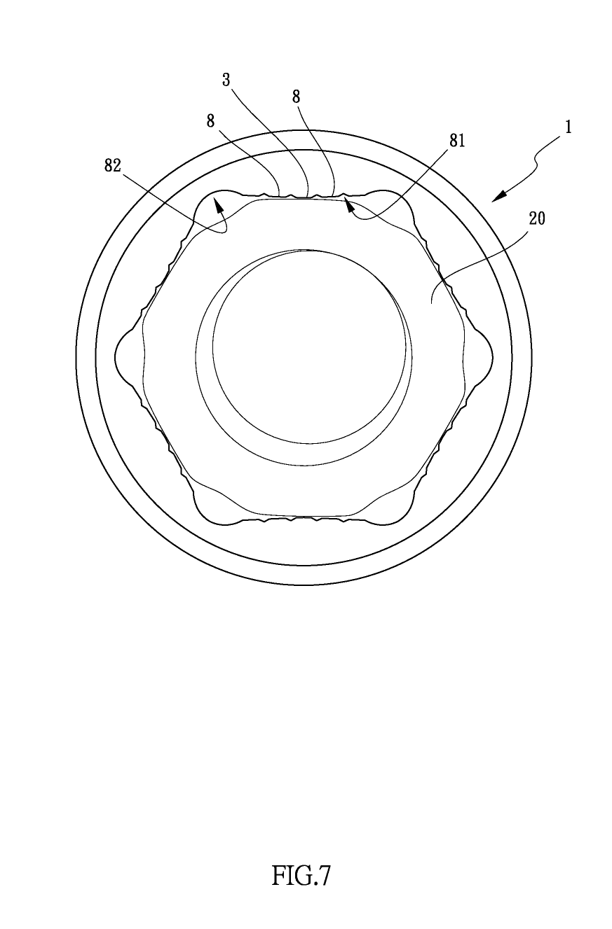

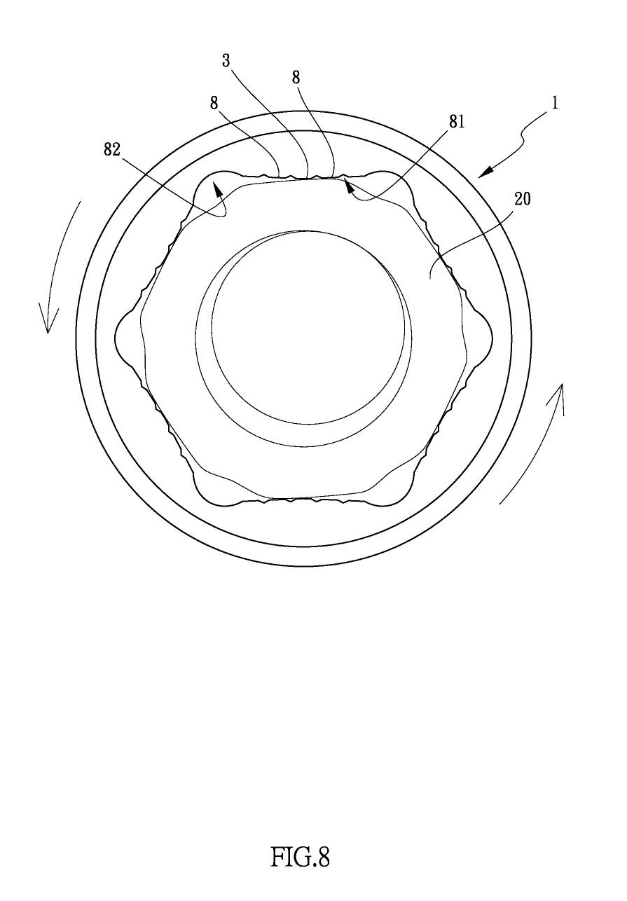

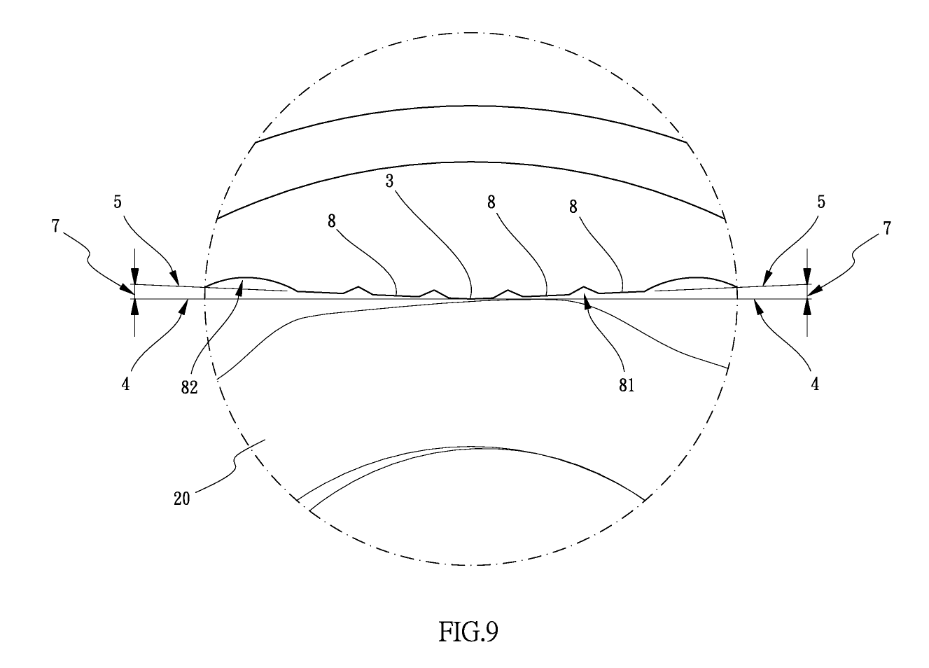

Referring to FIGS. 1 to 9, the socket 1 of the present invention is cooperated with a wrench 10 to loosen a bolt 20. The socket 1 comprises a body with a mounting hole 11 defined axially therethrough. The body includes a connection section 12 and a driving section 13, wherein the mounting hole 11 in the connection section 12 is a first hole 131 which is a rectangular hole, and the mounting hole 11 in the driving section 13 is a second hole 132 which is a polygonal hole. The connection section 12 is to be connected with the wrench 10, and the driving section 13 is to be mounted to the bolt 20.

The mounting hole 11 in the driving section 13 includes multiple faces 2, and each face 2 comprises a first protrusion 3 protruding from the central portion thereof. A first imaginary plane 4 extends in parallel from the distal surface of each first protrusion 3. Two second imaginary planes 5 respectively extend laterally from center of the distal surface of each first protrusion 3. An angle 7 is defined between the first imaginary plane 4 and each of the second imaginary planes 5. The angle 7 is larger than 0 degree, and the maximum value of the angle 7 is 5 degrees. Preferably, the angle 7 is 2 degrees.

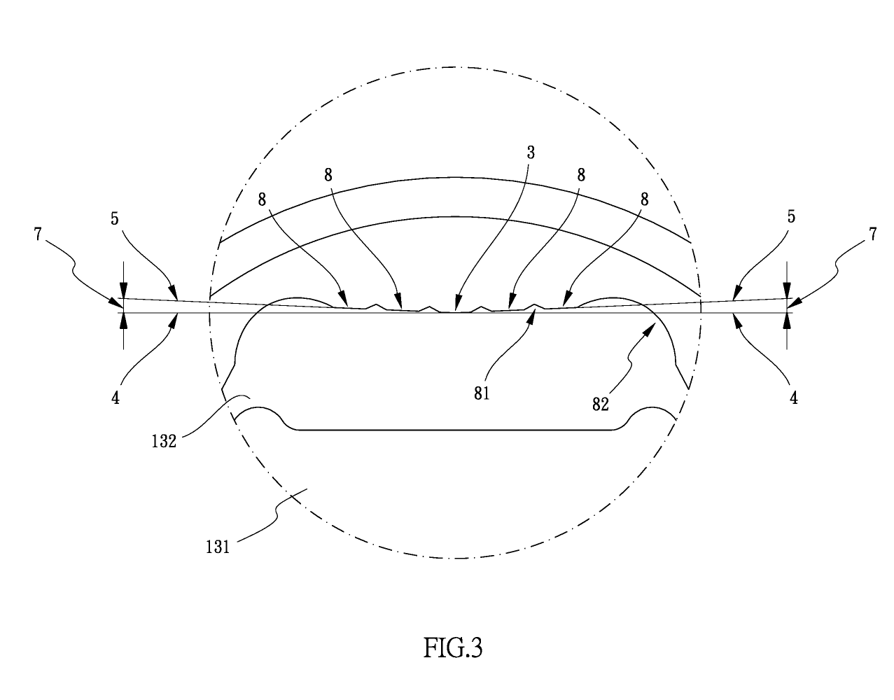

Multiple second protrusions 8 protrude from each face 2 of the mounting hole 11 and are arranged into two groups. The first protrusion 3 is located between the two groups of the second protrusions 8. Each of the second imaginary planes 5 passes respective distal surfaces of the second protrusions 8 of each group in parallel. That is to say, as shown in FIG. 3, the second protrusions 8 of each group is gradually tilt along the second imaginary plane 5. A curved groove 82 is defined axially between adjacent faces 2 of the mounting hole 11. A triangular notch 81 is defined axially between adjacent second protrusions 8.

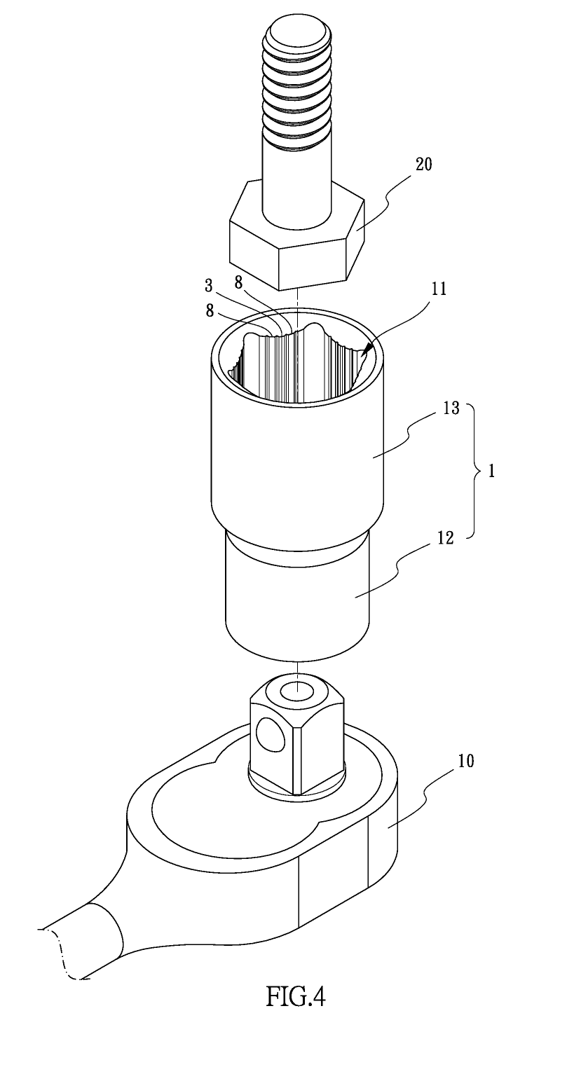

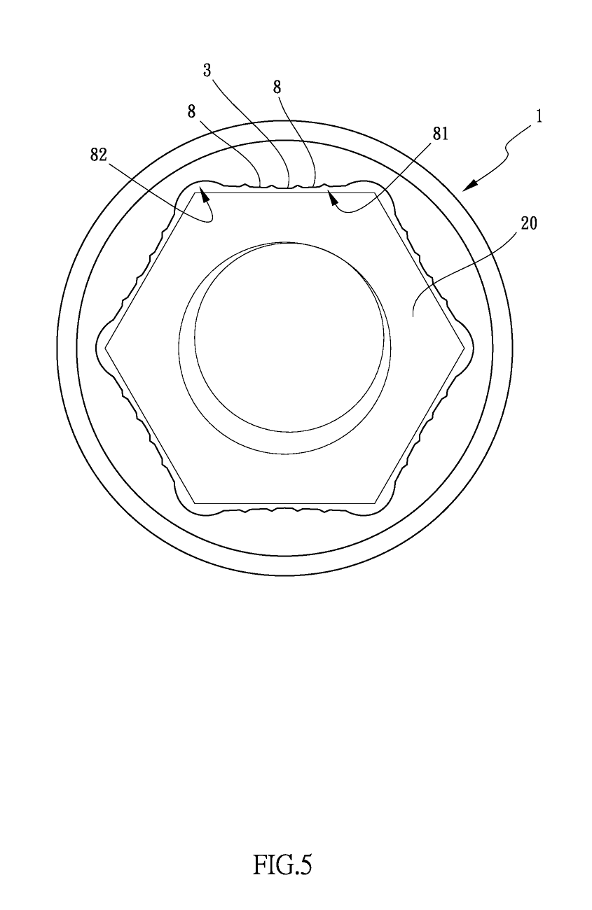

As shown in FIGS. 4 and 5, when loosening a normal bolt 20, the six sides of the head of the bolt 20 are in contact with the faces 2 of the mounting hole 11. When rotating the wrench 10, the socket 1 is rotated to rotate the bolt 20.

As shown in FIGS. 5 to 9, when loosening a rounded or damaged bolt 20, the second protrusions 8 are in contact with the six sides of the head of the bolt 20 so that when rotating the wrench 10, the socket 1 is rotated to rotate the bolt 20.

One of the embodiment of the socket 1 is described hereinafter, wherein the width of each face 2 is 55 mm, and the width of each notch 81 is 0.38 mm and the depth of each notch 81 is 0.1 mm. The width of each second protrusion 8 is 0.56 mm, and the width of each first protrusion 3 is 0.5 mm. The socket 1 of the present invention can effectively rotate normal or rounded/damaged nut or bolt.

While we have shown and described the embodiment in accordance with the present invention, it should be clear to those skilled in the art that further embodiments may be made without departing from the scope of the present invention.

What is claimed is:

1. A socket (1) comprising:
a body with a mounting hole (11) defined axially therethrough, the mounting hole (11) including multiple faces (2), each face (2) comprising a first protrusion (3) protruding from a central portion thereof, a first imaginary plane (4) extending in parallel from a distal surface of each first protrusion (3), two second imaginary planes (5) respectively extending laterally from a center of the distal surface of each first protrusion (3), an angle (7) defined between the first imaginary plane (4) and each of the second imaginary planes (5), and
multiple second protrusions (8) protruding from each face (2) of the mounting hole (11) and arranged into two groups, the first protrusion (3) located between the two groups of the second protrusions (8), each of the second imaginary planes (5) passing respective distal surfaces of the second protrusions (8) of each group in parallel.

2. The socket as claimed in claim 1, wherein the angle (7) is larger than 0 degree, a maximum value of the angle (7) is 5 degrees.

3. The socket as claimed in claim 1, wherein the angle (7) is 2 degrees

4. The socket as claimed in claim 1, wherein a groove (82) is defined axially between adjacent faces (2) of the mounting hole (11).

5. The socket as claimed in claim 4, wherein a notch (81) is defined axially between adjacent second protrusions (8).

6. The socket as claimed in claim 1, wherein the body includes a connection section (12) and a driving section (13), the mounting hole (11) in the connection section (12) is a first hole (131) which is a rectangular hole, the mounting hole (11) in the driving section (13) is a second hole (132) which is a polygonal hole.
